(19) United States
(12) Patent Application Publication
(10) Pub. No.: US 2024/0246043 A1
(43) Pub. Date: Jul. 25, 2024

(54) ROTOR BLADES FOR A MIXER WITH EXTENDED PROTRUSION ON THE ROTOR BLADES

(71) Applicant: SANSO MIXING AB, HORBY (SE)

(72) Inventors: Nemo IVARSSON, Stockholm (SE); Mats ANDERSSON, HORBY (SE)

(21) Appl. No.: 18/290,523

(22) PCT Filed: May 17, 2022
(86) PCT No.: PCT/SE2022/050480

§ 371 Date: Nov. 14, 2023

(30) Foreign Application Priority Data
May 18, 2021 (SE) 2150631-6

(51) Int. Cl. B01F 27/1123; B01F 27/072

(52) U.S. Cl. CPC B01F 27/1123; B01F 27/0721; B01F 2215/0409; B01F 2215/0422; B01F 2215/0431

(57) ABSTRACT

The present invention describes a rotor blade 1 intended for a rotor in a mixer, said rotor blade 1 having a main body 2 and multiple rotor wings 3 extending out from one side 2a of the main body 2, wherein at least one of the multiple rotor wings 3 has a protrusion 4 provided along the extension of said at least one rotor wing 3, wherein, in a front side of the rotor wing 3 in a rotational direction, said at least one rotor wing 3 extends through a point A2 being a point furthest away from the rotational direction and further up extends through a point A1 being a point furthest into the rotation direction, and wherein the point A1 is provided as a most vertical top end point of the protrusion 4 or at least in a horizontal top end plane of the protrusion 4.

### FIELD OF THE INVENTION

The present invention relates to a rotor blade.

### SUMMARY OF THE INVENTION

The present invention is directed to a rotor blade intended for a rotor in a mixer, said rotor blade having a main body and multiple rotor wings extending out from one side of the main body, wherein at least one of the multiple rotor wings has a protrusion provided along the extension of said at least one rotor wing, wherein, in a front side of the rotor wing in a rotational direction, said at least one rotor wing extends through a point A₂ being a point furthest away from the rotational direction and further up extends through a point A₁ being a point furthest into the rotation direction, and wherein the point A₁ is provided as a most vertical top end point of the protrusion or at least in a horizontal top end plane of the protrusion. The point A₁ should be provided as the uppermost vertical point of the rotor wing. This may be provided in a horizontal plane, either as a portion which then extends in an inclination downwards or as a totally horizontal plane until the backend of the rotor wing, which then continuous in a vertical back part of the rotor wing.

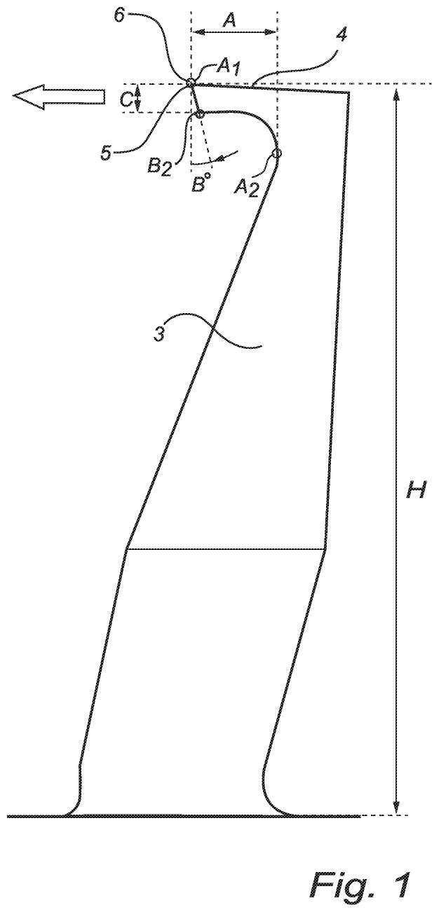

Moreover, it should be noted that the “protrusion” part of the rotor wing should be seen as everything extending upwards from the point A₂ (see the example in FIG. 1).

It should be noted that preferably the rotor blade comprises multiple rotor wings where several of them have a protrusion provided along the extension of said at least one rotor wing, most preferably all of them have such a protrusion. In line with this, according to one embodiment of the present invention, at least several of the multiple rotor wings have protrusions, preferably at the ends of the multiple rotor wings.

### SPECIFIC EMBODIMENTS OF THE INVENTION

Some specific embodiments of the present invention are disclosed below.

According to one embodiment, said at least one rotor wing extends through the point A₂ being a point furthest away from a rotational direction and further up extends through the point A₁ being a point furthest into the rotation direction, said points A₂ and A₁ having a distance A between each other so that A>0. One example is shown in FIG. 1. It should be noted that the distance A may be low, but at least above 0. To ensure to have a distance A, which also implies some form of angle or bent when the rotor wings extend up and out to its end. This ensure to prevent material to be filled up against the ceiling of a mixer and also prevents heat generation inside the mixer. The rotor blade according to the present invention provides an optimization so that the mentioned problems above are avoided and where the mixed material is driven out from the rotor space and thus mixer apparatus in an efficient way.

According to another embodiment, the protrusion is at an end of said at least one rotor wing. This position provides the best technical effect of the protrusion. Alternatives here are possible according to the invention, but it is preferred to provide the protrusion at the end of said at least one rotor wing.

According to yet another embodiment of the present invention, the end of the protrusion has a thickness C, extending from a bottom point B₂ to the top point, preferably to a top point A₁ being a point furthest into the rotation direction, preferably wherein C is in the range of 3-30 mm. This thickness C has several advantages. First of all, it prevents a hot spot at the protrusion end. With a full tip design instead, then the effect of pressing mixed material in the right direction is not as efficient. Therefore, to provide a thickness C of the end of the protrusion in the rotational direction ensures a gentler processing of the material being mixed. Secondly, this thickness C together with a perpendicular direction thereof (see a direction into the paper for the embodiment shown in FIG. 1) forms a plane that may contribute to this pressing effect in the intended direction and also contribute to preventing temperature hot spots. This is discussed further below.

Furthermore, according to yet another embodiment, the top point A₁ is further into the rotation direction than the bottom point B₂ of the end of the protrusion, which implies that the end of the protrusion is inclined or bent outwards in the rotational direction, seen from the bottom point B₂ and up to the top point A₁. One such alternative is shown in FIG. 1. This type of design of the end is also of importance for an efficient pressing effect as mentioned above. Furthermore, also here a possible cross section of the protrusion should be considered.

Moreover, according to one specific embodiment of the present invention, the bottom point B₂ and the top point A₁ defines and angle B° with an imaginary perpendicular end of the protrusion, and wherein angle B° is in the range of from −15° to 60°.

According to yet another embodiment, there is provided an end surface arranged from the top point A₁ to the bottom point B₂ of the end, and wherein the end surface has an inclination or is concave, preferably is inclined with a “let go” where the rotor wing decreases geometrically so that material is let go from the wing more efficiently. This end surface should be seen as the cross sectional area mentioned above in relation to distance C.

According to one embodiment, the height H of said at least one rotor wing extends from said one side of the main body of the rotor blade and to the top of said at least one rotor wing, preferably wherein the top is in a point A₁ being a point furthest into the rotation direction, wherein H is at least 2*A, preferably wherein A/H is in a range of 1/50-2/5, more preferably wherein A/H is in a range of 1/25-1/5, most preferably A is maximum 300 mm. The preferred ranges ensure a gentle processing of the material, however the optimal relationship depends on the material intended to be mixed.

Moreover, according to yet another embodiment of the present invention, the height H of said at least one rotor wing extends from said one side of the main body of the rotor blade and to the top of said at least one rotor wing, and wherein H is less than D where D is the diameter of the main body of the rotor blade, preferably H is at most D/2. Also here, this relationship is of interest to provide for a gentle but efficient mixing.

Furthermore, according to yet another embodiment, the protrusion is provided as a hook extension at an end of said at least one rotor wing, said hook extension implying that said at least one rotor wing extends with a non-perpendicular angle from the main body in a direction pointing away from the rotational direction, somewhere along the extension of said at least one rotor wing, and then bends back in the rotational direction to provide for the hook extension in the rotational direction.

According to one embodiment, said multiple rotor wings extend from an outer periphery of the main body, said main body preferably being circular. This arrangement provides for an efficient mixing effect, but is should be noted that all rot wings do not have to have this position. Combinations of several rot wings in the periphery and some somewhat closer to the center of the main bode are possible.

According to yet another embodiment, said multiple rotor wings extend perpendicular from a geometrical XY coordinate plane of said one side of the main body or extend with an angle in a X direction and/or an angle in the Y direction from a totally perpendicular extension from the geometrical XY coordinate plane of said one side of the main body. This implies that the rotor wings may extend perpendicularly or with a perpendicular angel from the main body.

Moreover, according to yet another embodiment, the rotor blade has a center unit intended for connecting the rotor blade to a rotor in a mixer.

### DESCRIPTION OF THE DRAWINGS

In FIG. 1 there is shown a rotor wing 3 according to one embodiment of the present invention. The rotor wing 3 has a protrusion 4 provided along the extension of said at least one rotor wing 3. As may be seen, in a front side of the rotor wing 3 in a rotational direction, said at least one rotor wing 3 extends through a point A₂ being a point furthest away from the rotational direction and further up extends through a point A₁ being a point furthest into the rotation direction, and wherein the point A₁ in this case is provided as a most vertical top end point of the protrusion 4. Furthermore, in this case said at least one rotor wing 3 extends through a point A₂ being a point furthest away from a rotational direction and further up extends through a point A₁ being a point furthest into the rotation direction, said points A₂ and A₁ having a distance A between each other so that A>0. Moreover, the rotor wing also has a top 6. Furthermore, according to this embodiment, the end 5 of the protrusion 4 has a thickness C, extending from a bottom point B₂ to the top point, and in this case to a top point A₁ being a point furthest into the rotation direction.

Moreover, in this embodiment, the bottom point B₂ and the top point A₁ defines and angle B° with an imaginary perpendicular end 5 of the protrusion 4. Furthermore, the height H of said at least one rotor wing 3 extends from one side 2a of the main body 2 of the rotor blade 1 and to the top 6 of said at least one rotor wing 3, wherein H is at least 2*A.

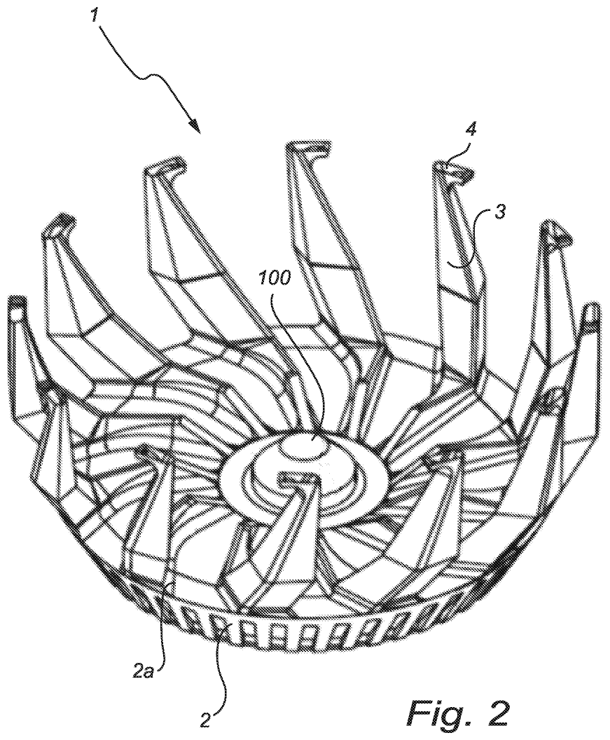

In FIG. 2 there is shown a rotor blade according to one embodiment of the present invention. The rotor blade 1 has a main body 2 and multiple rotor wings 3 extending out from one side 2a of the main body 2, and where, in this case, all the multiple rotor wings 3 have a protrusion 4 provided along the extension of each rotor wing 3. Moreover, in this case the rotor blade 1 has a center unit 100 intended for connecting the rotor blade 1 to a rotor in a mixer.

1. A rotor blade intended for a rotor in a mixer, said rotor blade having a main body and multiple rotor wings extending out from one side of the main body, wherein at least one of the multiple rotor wings has a protrusion provided along the extension of said at least one rotor wing, wherein, in a front side of the rotor wing in a rotational direction, said at least one rotor wing extends through a point A₂ being a point furthest away from the rotational direction and further up extends through a point A₁ being a point furthest into the rotation direction, and wherein the point A₁ is provided as a most vertical top end point of the protrusion or at least in a horizontal top end plane of the protrusion.

2. The rotor blade according to claim 1, wherein said at least one rotor wing extends through the point A₂ being a point furthest away from a rotational direction and further up extends through the point A₁ being a point furthest into the rotation direction, said points A₂ and A₁ having a distance A between each other so that A>0.

3. The rotor blade according to claim 1, wherein the protrusion is at an end of said at least one rotor wing.

4. The rotor blade according to claim 3, wherein the end of the protrusion has a thickness C, extending from a bottom point B₂ to the top point, preferably to a top point A₁ being a point furthest into the rotation direction, preferably wherein C is in the range of 3-30 mm.

5. The rotor blade according to claim 4, wherein the top point A₁ is further into the rotation direction than the bottom point B₂ of the end of the protrusion, which implies that the end of the protrusion is inclined or bent outwards in the rotational direction, seen from the bottom point B₂ and up to the top point A₁.

6. The rotor blade according to claim 5, wherein the bottom point B₂ and the top point A₁ defines and angle B° with an imaginary perpendicular end of the protrusion, and wherein angle B° is in the range of from −15° to 60°.

7. The rotor blade according to claim 1, wherein there is provided an end surface arranged from the top point A₁ to the bottom point B₂ of the end, and wherein the end surface has an inclination or is concave, preferably is inclined.

8. The rotor blade according to claim 2, wherein the height H of said at least one rotor wing extends from said one side of the main body of the rotor blade and to the top of said at least one rotor wing, preferably wherein the top is in a point A₁ being a point furthest into the rotation direction, wherein H is at least 2*A, preferably wherein A/H is in a range of 1/50-2/5, more preferably wherein A/H is in a range of 1/25-1/5, most preferably A is maximum 300 mm.

9. The rotor blade according to claim 2, wherein the height H of said at least one rotor wing extends from said one side of the main body of the rotor blade and to the top of said at least one rotor wing, and wherein H is less than D where D is the diameter of the main body of the rotor blade, preferably H is at most D/2.

10. The rotor blade according to claim 2, wherein the protrusion is provided as a hook extension at an end of said at least one rotor wing, said hook extension implying that said at least one rotor wing extends with a non-perpendicular angle from the main body in a direction pointing away from the rotational direction, somewhere along the extension of said at least one rotor wing, and then bends back in the rotational direction to provide for the hook extension in the rotational direction.

11. The rotor blade according to claim 1, wherein at least several of the multiple rotor wings have protrusions, preferably at the ends of the multiple rotor wings.

12. The rotor blade according to claim 1, wherein said multiple rotor wings extend from an outer periphery of the main body, said main body preferably being circular.

13. The rotor blade according to claim 1, wherein said multiple rotor wings extend perpendicular from a geometrical XY coordinate plane of said one side of the main body or extend with an angle in a X direction and/or an angle in the Y direction from a totally perpendicular extension from the geometrical XY coordinate plane of said one side of the main body.

14. The rotor blade according to claim 1, wherein the rotor blade has a center unit intended for connecting the rotor blade to a rotor in a mixer.
